(19) United States
(12) Patent Application Publication
(10) Pub. No.: US 2014/0138115 A1
(43) Pub. Date: May 22, 2014

(54) SUBSEA UMBILICAL

(71) Applicant: NEXANS, Paris (FR)

(72) Inventors: Stian Karlsen, Halden (NO); Magnus Hurlen Larsen, Nesoya (NO)

(21) Appl. No.: 14/065,634

(22) Filed: Oct. 29, 2013

(30) Foreign Application Priority Data
Nov. 19, 2012 (NO) NO 20121361

(51) Int. Cl. H01B 7/18; H01B 7/14

(52) U.S. Cl. CPC H01B 7/18; H01B 7/14
USPC 174/24; 174/110 R

(57) ABSTRACT

The present arrangement provides an umbilical 1 for subsea application having at least one power phase 9, each power phase comprises at least one conductor 2. The at least one conductor is a massive conductor made in aluminium, or any suitable alloy thereof, and has sufficient tensile strength to ensure that the umbilical supports operating loads without requiring any additional load bearing elements.

### RELATED APPLICATION

This application claims the benefit of priority from Norwegian Patent Application No. 2012 1361, filed on Nov. 19, 2012, the entirety of which is incorporated by reference.

### FIELD OF INVENTION

The present invention relates to improved umbilicals or cables having a power phase conductor, and more particularly subsea umbilicals or cables comprising an aluminium conductor.

### BACKGROUND

An umbilical consists of a group of one or more types of elongated active umbilical elements, such as electrical phases, optical fiber cables, steel tubes and/or hoses, over-sheathed and, when applicable, armored for mechanical strength. Umbilicals are typically used for transmitting power, signals and fluids (for example for fluid injection or hydraulic power) to and from a subsea installation.

The umbilical cross-section is generally circular, the elongated elements being wound together either in a helical or in a S/Z pattern. In order to fill the interstitial voids between the various umbilical elements and obtain the desired configuration, filler components may be included within said voids.

Subsea umbilicals are installed at increasing water depths, commonly deeper than 1000 m. Such umbilicals have to be able to withstand severe loading conditions during their installation and their service life. Additional load bearing elements, such as armoring wires in the outer layers of the umbilical, are used to withstand the loads.

The remaining elements of an umbilical, for instance the electrical and optical cables, the thermoplastic hoses, the polymeric external sheath and the polymeric filler components, do not contribute significantly to the tensile strength of the umbilical.

Electrical cables used in subsea umbilicals fall into two distinct categories respectively known as signal cables and power phases.

Signal cables are used for transmitting signals and low power (<1 kW) subsea, such as to electrical devices on the seabed. Signal cables are generally rated at a voltage smaller than 3000V, and typically smaller than 1000V. Signal cables generally consist of small-section insulated conductors bundled together as pairs (2), quads (4) or, very rarely, any other number, the bundle then being over-sheathed.

Power phases within umbilicals are used for transmitting high electrical power (typically a few MW) subsea, for instance to power subsea equipment such as pumps. The power phases are generally rated at a medium voltage comprised between 6 kV and 35 kV, but may also exceed this limit.

An umbilical comprising at least one power phase is often termed a power umbilical. Thus, a power umbilical includes one or more electrical power phases. These power phases are in the prior art formed from a conductor, formed from a plurality of strands.

The conductors of these power phases within a subsea power umbilical are generally copper. They are not load bearing components because of the low yield strength and the high specific gravity of copper. Moreover, these heavy copper conductors add considerable weight to an umbilical and have very poor load carrying capacity. Unless protected, these electrical conductors may be damaged by excessive elongation, i.e. tensile load, or crushing, especially under severe conditions such as in deep water and/or dynamic umbilicals.

Patent application US 2012/0061123 A1 discloses power umbilicals comprising one or more power phases. The power phases are constructed of stranded conductors, wherein at least some of the strands are aluminium, more particularly aluminium of the 6000-series. By using aluminium instead of copper as material in the conductors, the tensile strength to weight ratio of the power phase is increased. Such umbilicals may even be constructed without additional load bearing elements due to the high tensile strength and the low specific gravity of the aluminium conductor(s).

The designation of various types of aluminium alloys used in the present disclosure is defined in the European Standard EN 573-1 “Aluminium and aluminium alloys—Chemical composition and form of wrought products—Part 1: Numerical designation system”. The four-digit numerical designation system specified in this European Standard is in accordance with the International Alloy Designation System (LADS) developed by the Aluminium Association, Arlington Va. 22209, USA. The first of the four digits in the EN 573/IADS designation system indicates the major alloying elements of the aluminium or aluminium alloy. When it is equal to 1, the corresponding material belongs to the “1000 series”, and is almost pure wrought aluminium, i.e. comprising 99% or more aluminium. When it is equal to 6, the corresponding material is an aluminium alloy belonging to the “6000 series”, and its major alloying elements are magnesium and silicon, which forms hardening precipitates to give better mechanical properties after heat treatment.

The use of stranded aluminium conductors without sealing between the strands, as disclosed in US 2012/0061123 A1, poses a potential problem when used in subsea applications. In addition to the voids between the various elements in an umbilical as mentioned above, the stranded conductors described in US 2012/0061123 A1 also have voids in between the plurality of strands. In sea water, especially at deep water, it is important to prevent water and gas to diffuse into the conductor. Water might reduce the lifetime of the power phase by inducing water treeing, especially for higher voltages. Even though a protective metallic barrier may be applied around the power phase preventing radial water diffusion, a water tight conductor is necessary for preventing water ingress along the conductor in case of a repair scenario. If there are interstices between the strands, water will migrate along the conductor from where damage has made a hole through the insulation. In such cases, repair is not possible and the whole cable must be replaced.

A water tight conductor is especially important if the conductor is made of aluminium or aluminium alloy. The inner semi conductive layer facing the conductor contains carbon. This material is therefore very noble compared to aluminium. Hence even small amounts of water will create a galvanic cell that makes the conductor corrode. It is proven by testing that even small amounts of corrosion might create cable failure, as corrosion products initiate water treeing and thereby insulation break down.

Gas blocking is important for power phases inside umbilicals. Hydrogen is created from cathodic protection of sub sea structures, and methane gas may be created from the insulation system itself. If there are voids in the conductor, like interstices between the strands, the pressure difference between the surrounding water and the voids create a force for these gases to migrate into the conductor. These gases will then be transported along the interstices in the conductor and create a great potential for explosion on a production vessel for hydrocarbons.

It is an object of the present invention to overcome the problems related to the use of stranded conductors in power cables or umbilicals used in subsea applications.

### SUMMARY OF THE INVENTION

The present invention provides a solution to the problems related to stranded conductors in subsea environments, and more particularly stranded aluminium conductors. The applicant has discovered that the prior art stranded aluminium conductors, may advantageously be substituted by massive, or solid, aluminium conductors made of a suitable aluminium alloy. The problems caused by voids in stranded aluminium conductors are thus avoided. By use of said conductors, the need for additional load bearing elements in the umbilical is removed. The present invention is defined in the appended claims and by the following:

The present invention provides an umbilical for subsea application comprising at least one power phase, each power phase comprises at least one conductor, wherein the at least one conductor is a massive conductor made in aluminium or any suitable alloy thereof, and wherein the at least one conductor has sufficient tensile strength to ensure that the umbilical supports operating loads without requiring any additional load bearing elements.

The operating loads on the umbilical are the loads the umbilical is subjected to. These loads comprise the tensile strain due to the suspended weight of the umbilical and the strain caused for instance during installation operations.

In one aspect of the invention, the conductor is made in an aluminium alloy chosen from the group consisting of the 1000-series, 3000-series, 5000-series, 6000-series and the 7000-series, as defined according to the European Standard EN 573-1.

In a further aspect of the invention, the aluminium alloy of the conductor is chosen from one that is designated 1120, 1350, 1370, 6101 or 6201.

In a further aspect of the invention, all voids between longitudinal elements of the umbilical are filled with a filling material.

The filling material is a material suitable for preventing the incursion of gas and water into the longitudinal voids between the various elements of the umbilical. Such elements include electrical phases, optical fiber cables, steel tubes and/or hoses and outer sheathing. The filling material is preferably a fluid, which may also comprise hollow elements to improve buoyancy of the umbilical.

### BRIEF DESCRIPTION OF THE DRAWINGS

FIG. 1: a cross-section of a prior art power umbilical comprising stranded conductors.

FIG. 2: a sectional view of a stranded conductor used in prior art power umbilicals.

FIG. 3: a cross-section of a power umbilical according to the invention.

FIG. 4: a sectional view of a stranded conductor used in power umbilicals according to the present invention.

### DETAILED DESCRIPTION OF THE DRAWINGS

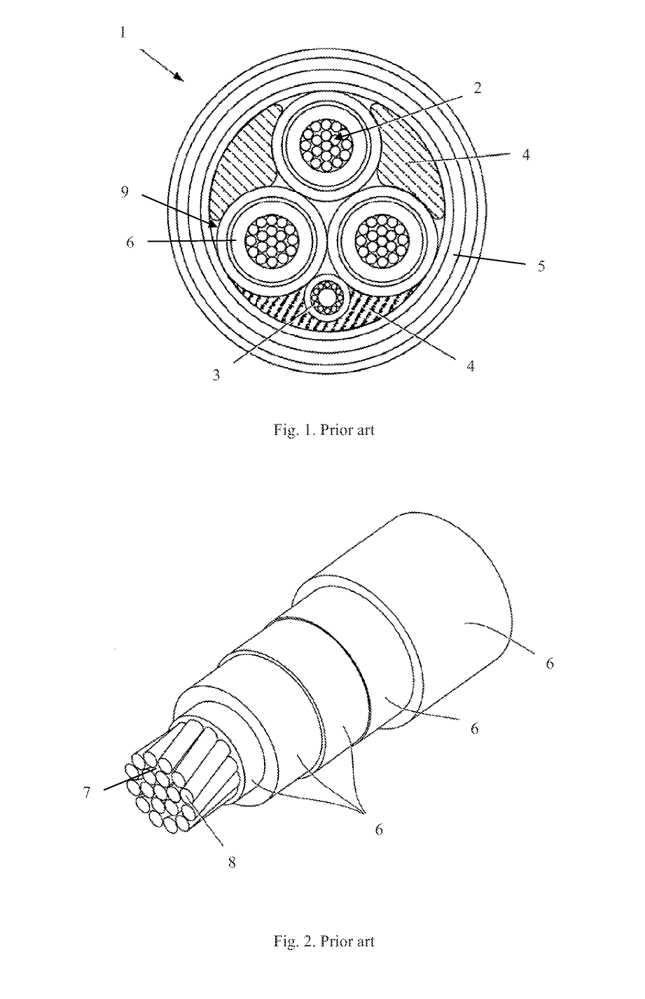

A prior art power umbilical 1 is shown in FIG. 1. The umbilical shown here comprises three power phases with conductors 2, and is suitable for providing a 3-phase power supply. The conductors are each surrounded by various sheaths 6 for insulation and protection of said conductors. In addition, the shown umbilical has an optical fiber cable 3. The conductors and the optical fiber cable are supported within the surrounding protective sheaths 5 by filler materials 4. The purpose of the filler material is to hold the conductors and fiber cable in a fixed position relative to each other, and to prevent incursion of water into the umbilical. A power phase comprising a single conductor 2 is shown in FIG. 2. An umbilical may comprise an optional number of such phases depending on the intended application. The conductors 2 are each made up of multiple strands 8, see FIG. 2. Due to the multiple strands, the conductors have multiple voids 7 between the strands in the longitudinal direction of the umbilical. The layup of the strands, as well as pressing the strands close together, may contributes to lessen the size of the longitudinal voids 7, but do not remove them. Such conductors are thus vulnerable towards detrimental accumulation of gasses and water in the longitudinal voids.

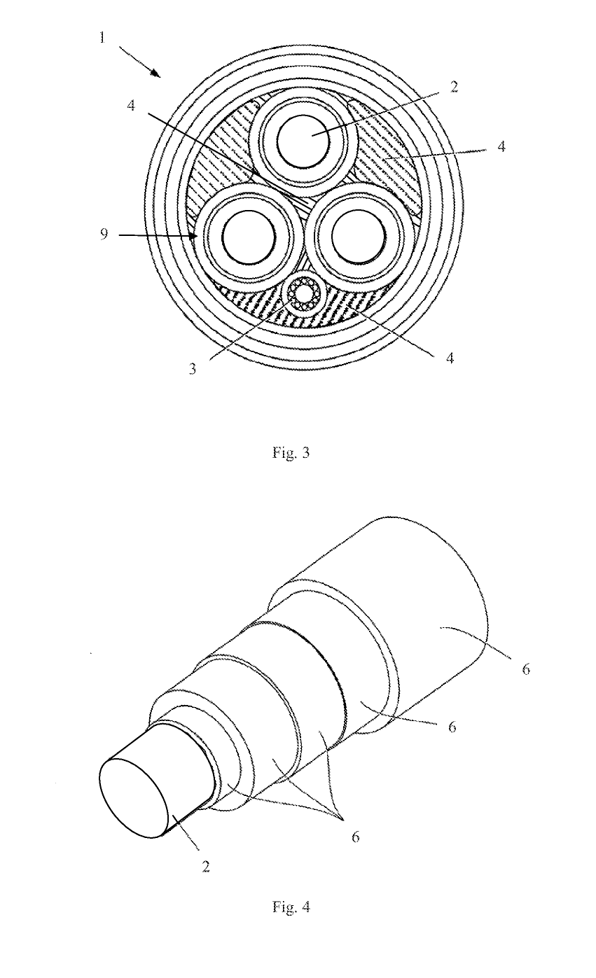

An embodiment of an umbilical according to the present invention is shown in FIG. 3. As shown in the prior art umbilical in FIG. 1, the umbilical in FIG. 3 comprises three conductors 2, as well as an optical fiber cable 3. The conductors are not made up of multiple strands, but are massive, or solid, non-stranded conductors made of an appropriate aluminium alloy. An appropriate alloy should have the right combination of properties related to conductance and strength. Ideally, the strength of the alloy is such that the conductors are able to withstand the various loads on the umbilical without requiring additional elements to provide structural strength, such as armoring wires in the protective sheath 5. Since the conductors are massive they do not contain any longitudinal voids as in the prior art subsea umbilicals. Further, the filler material 4 fills preferably up all of the vacant space in the umbilical to avoid damage to the other elements of the umbilical. A single power conductor 2 for use in an umbilical according to the invention, i.e. a power phase, is shown in FIG. 4. An umbilical may comprise an optional number of such phases depending on the intended application

1. An umbilical for subsea application comprising:
at least one power phase, each power phase having at least one conductor,
wherein the at least one conductor is a massive conductor made in aluminium or any suitable alloy thereof, and
wherein the at least one conductor has sufficient tensile strength to ensure that the umbilical supports operating loads without requiring an additional load bearing elements.

2. The umbilical according to claim 1, wherein the aluminium alloy is selected from the group consisting of the 1000-series, 3000-series, 5000-series, 6000-series and the 7000-series, as defined according to the European Standard EN 573-1.

3. The umbilical according to claim 2, wherein the aluminium alloy is chosen from one that is designated 1120, 1350, 1370, 6101 or 6201.

4. The umbilical according to claim 1, wherein all voids between longitudinal elements of the umbilical are filled with a filling material.

5. The umbilical according to claim 4, wherein the filling material is a fluid, the fluid having hollow elements to improve buoyancy of the umbilical.
